(19) United States
(12) Patent Application Publication
(10) Pub. No.: US 2008/0150831 A1
(43) Pub. Date: Jun. 26, 2008

(54) Low AZEl Lockdown Shift Antenna Mount

(75) Inventor: Tommy Tulloch, Aberdour Burntisland (GB)

Correspondence Address: BABCOCK IP, PLLC, P.O.BOX 488, BRIDGMAN, MI, 49106, US

(73) Assignee: ANDREW CORPORATION, Westchester, IL (US)

(21) Appl. No.: 11/614,904

(22) Filed: Dec. 21, 2006

(51) Int. Cl. H01Q 3/02

(52) U.S. Cl. 343/882

(57) ABSTRACT

An antenna mount with low final lockdown pointing error characteristics especially suited for use with an antenna configuration having an offset center of gravity such as a reflector antenna. The antenna mount having a primary mount with a connecting surface for an azimuth plate; the azimuth plate coupled to the connecting surface by an az-pivot fastener; the azimuth plate pivotable about the az-pivot fastener with respect to the connecting surface; an az-lockdown fastener with an az-lockdown head coupled to the connecting surface; the az-lockdown fastener passing through the an az-lockdown slot of the azimuth plate; a retaining spacer of the az-lockdown fastener positioned in the az-lockdown slot between the connecting surface and an underside of the az-lockdown fastener head; the retaining spacer having a height greater than a thickness of the azimuth plate.

### BACKGROUND

For optimal performance, a directional antenna such as a reflector antenna must be closely aligned with a target signal source. Alignment of a reflector antenna is typically performed via an adjustable antenna mount that, with respect to a fixed mounting point, is adjustable in azimuth and elevation to orient the antenna towards the target signal source.

Antenna mount coarse adjustment is often cost effectively incorporated into an antenna mount via a movable connection coupled to a fixed point, for example via one or more slot(s) and or a pivot point and a slot along which the pivot angle of the movable connection may be fixed by tightening one or more fasteners. Fine adjustments are difficult to make in these arrangements because the targeting resolution along the slot(s) is very low due to the free movement of the movable connection until the bolt(s) are tightened. Further, the weight of the antenna acts as a cantilever on the associated fasteners, distorting the selected alignment by biasing the fasteners towards an open rather than lock down fastener position. After the desired alignment has been achieved, for example by monitoring signal peaking, tightening these fasteners to the lock down position causes the alignment to shift back, causing a pointing error that cannot be readily compensated by the installer. Furthermore, when the fastener(s) are tightened, imperfect bearing and contact points between the adjusting surfaces can cause additional pointing error as the mechanism distorts.

Where multiple feeds are applied to a single reflector to simultaneously receive closely spaced beams from different satellites, precision alignment is critical to achieve acceptable signal performance with respect to each of the satellites. High resolution adjustment capability may also be used for a single feed reflector and or terrestrial applications where precision alignment is desired. For example, the Ka Band has an especially strict alignment requirement

The adjustable antenna mount must support the entire antenna mass and also withstand any expected environmental factors such as wind shear and or ice loading. However, adjustable antenna mounts that are both sufficiently strong and easily adjustable with precision significantly increase the overall cost of the resulting antenna.

U.S. Pat. No. 7,046,210 “Precision Alignment Mount” by Brooker et al, issued May, 16, 2006, co-owned with the present invention by Andrew Corporation of Westchester, Ill., hereby incorporated by reference in the entirety, discloses an antenna mount with fine adjustment capabilities that applies bias springs and or belliview washers to minimize final tightening shift. However, these springs and or spring washers add complexity to the assembly operation, additional materials cost and over time the spring force of these elements may degrade, reducing their effect.

The increasing competition for reflector antennas and associated mounting assemblies adapted for both industrial and high volume consumer applications such as data, VSAT, satellite tv and or internet communications has focused attention on cost reductions resulting from increased materials, manufacturing and service efficiencies. Further, reductions in required assembly operations and the total number of discrete parts are desired.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with the general and detailed descriptions of the invention appearing herein, serve to explain the principles of the invention.

FIG. 1 is an exploded isometric view of an exemplary embodiment of the invention.

FIG. 2 is an elevated isometric rear angle view of the FIG. 1 antenna mount, assembled.

FIG. 3 is a rear view of FIG. 1, assembled.

FIG. 4 is a top view of FIG. 1, assembled.

FIG. 5 is a top view of FIG. 1, assembled.

FIG. 6 is a simplified exploded isometric view of portions of FIG. 1.

FIG. 7 is a partially exploded front isometric view of the FIG. 1 antenna mount, antenna mounting surface removed.

FIG. 8 is a cross sectional close-up view of FIG. 3, along line B-B.

FIG. 9 is a cross sectional close-up view of FIG. 4, along line L-L.

FIG. 10 is a cross sectional close-up view of FIG. 5, along line I-I.

### DETAILED DESCRIPTION

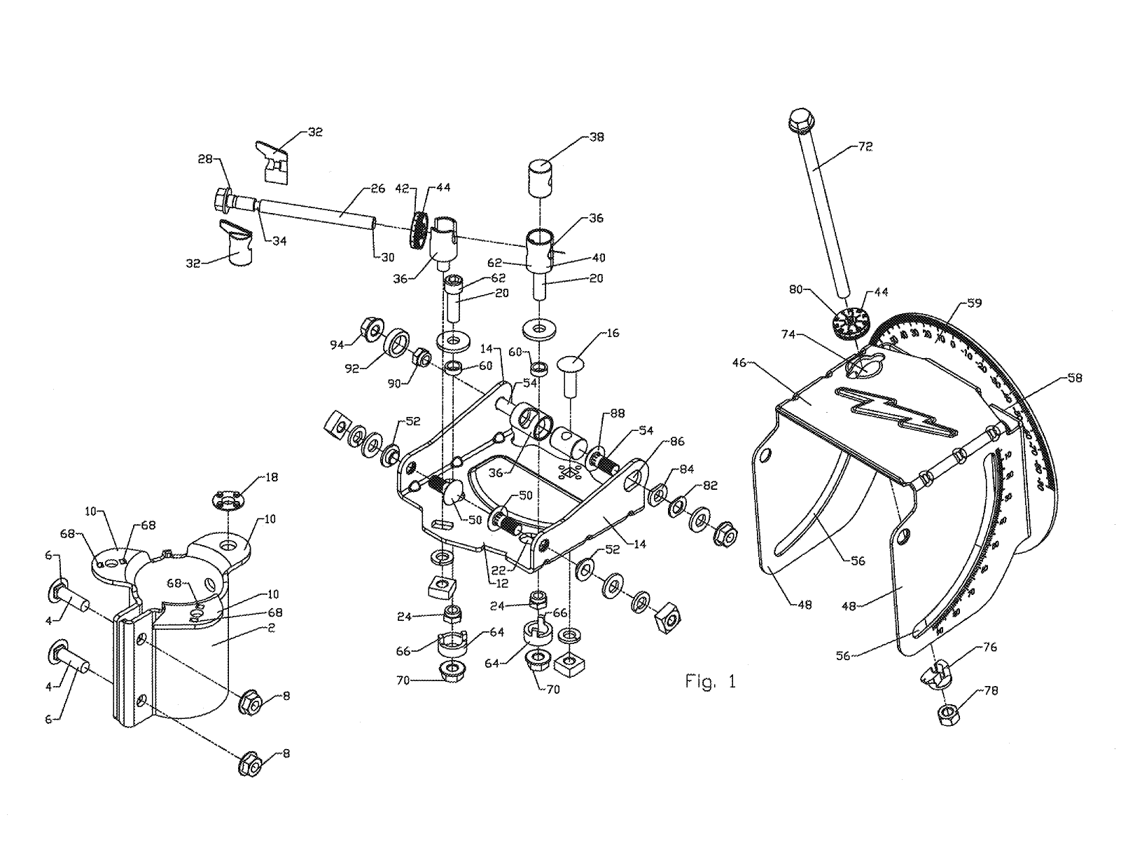

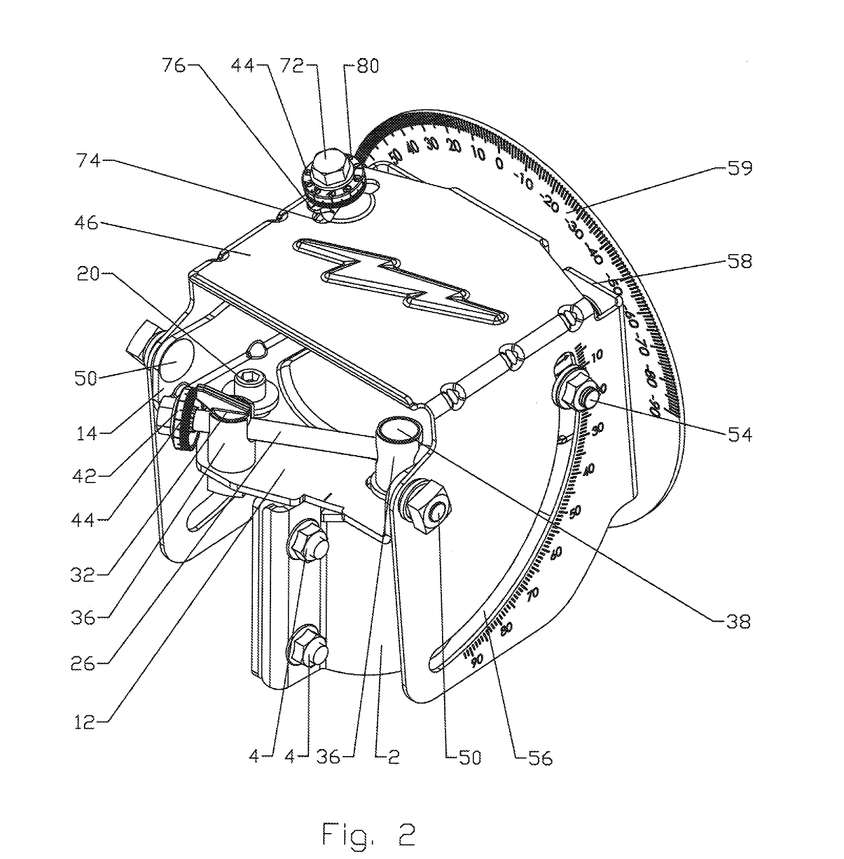

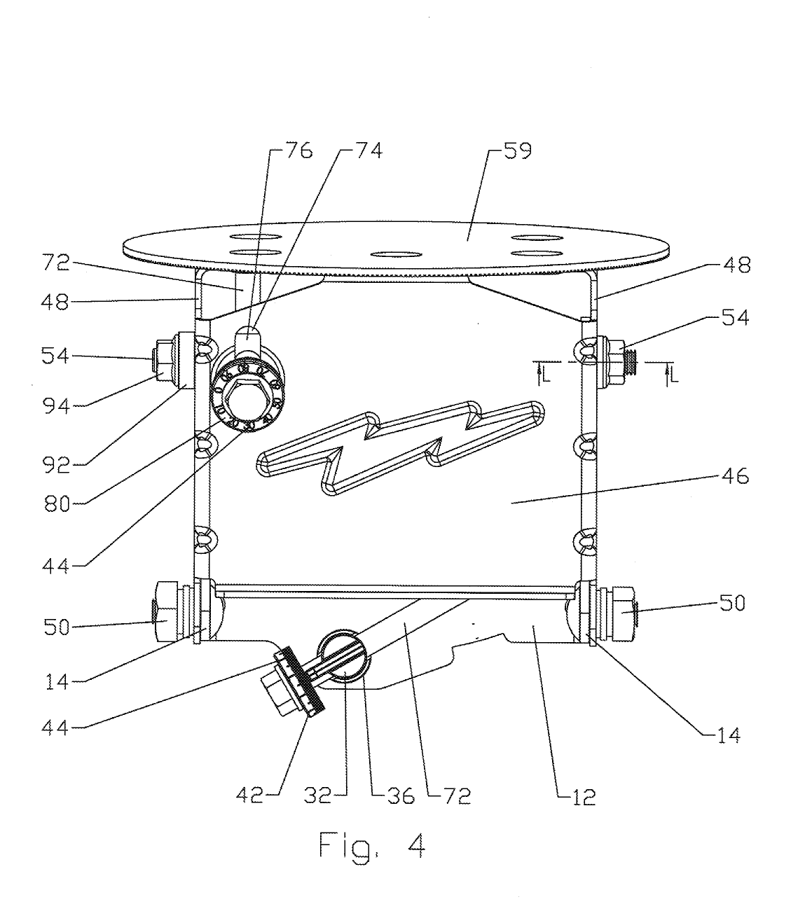

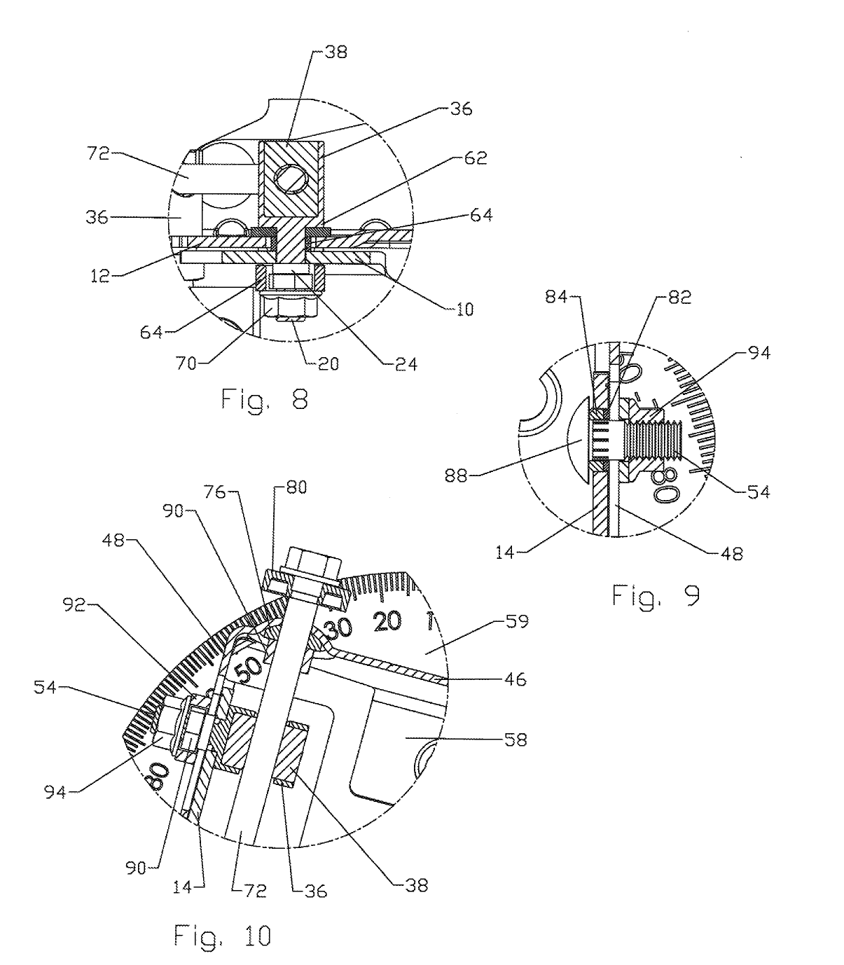

An exemplary embodiment of a fine adjusting antenna mount with improved final azimuth and elevation final lockdown pointing error characteristics is shown for example in FIGS. 1-10. A primary mount 2 is adapted to secure the antenna mount upon a desired mounting point. In the present embodiment, the primary mount 2 is a pipe clamp adapted to mount upon the end of a cylindrical mounting pole or mast (not shown) via clamp fasteners 4 such as a coach bolt 6 and serrated nut 8. Alternatively, the primary mount 2 may be any rigid connection to a desired mounting point. Coarse azimuth adjustment is effected by rotation of the primary mount 2 about the mounting point prior to final tightening of the, for example, clamp fasteners 4. The top of the primary mount 2 is provided with connecting surfaces 10 for an azimuth plate 12, here shown as a U-bracket with generally parallel azimuth angled ends 14. The connecting surfaces 10 are demonstrated as generally normal to a longitudinal axis of the primary mount 2.

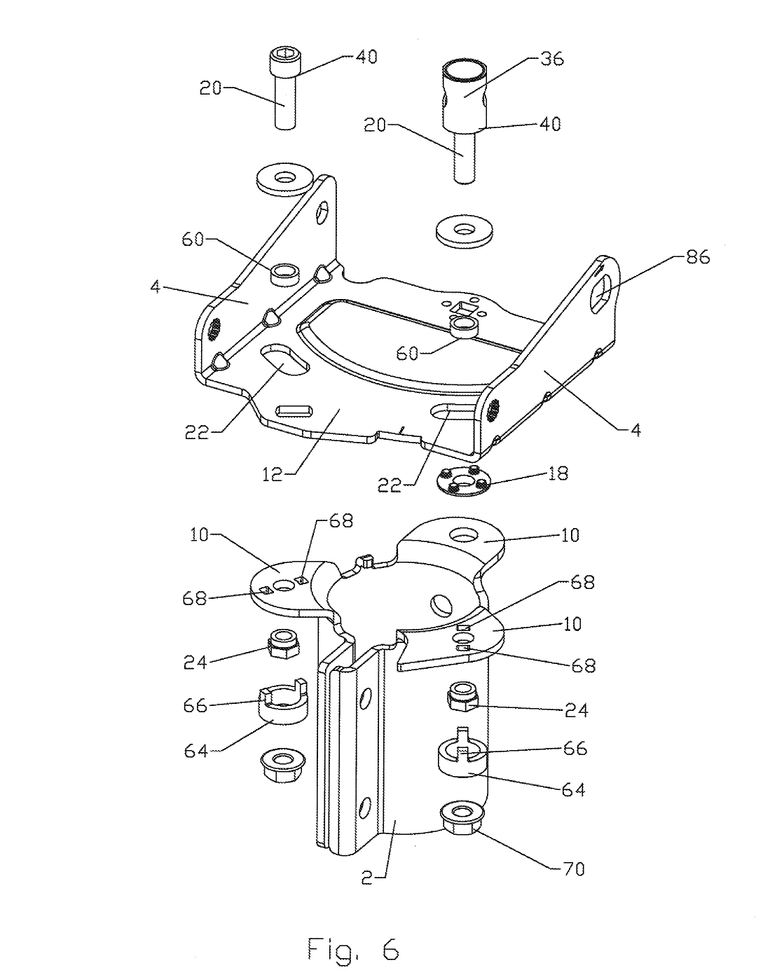

Fine azimuth adjustments are provided by a pivot action of the azimuth plate 12 with respect to the connecting surfaces 10 about an az-pivot fastener 16, such as a short neck coach bolt that couples the azimuth plate 12 to a connecting surface 10. Alternatively, the az-pivot fastener 16 may be a removable and or fastening force adjustable nut and bolt or a permanently connected fastener such as a rivet. A washer 18 (FIG. 6) or the like may be applied between the connecting surface 10 and the azimuth plate 12 at the az-pivot fastener 16 to improve the motion of the pivot action. The pivot action about the az-pivot fastener 16 is regulated by at least one az-lockdown fastener 20 connected to the connecting surface 10 via an az-lockdown slot 22 formed with an arc radius generally about the az-pivot fastener 16. The extents of the az-lockdown slot 22 define the range of available fine azimuth adjustment between the connecting surfaces 10 and the azimuth plate 12. An az-retaining nut 24 couples the az-lockdown fastener 20 to the connecting surface 10. The present embodiment is demonstrated with two az-lockdown fasteners 20 at two spaced apart connecting surfaces 10 and two corresponding az-lockdown slots 22 formed in the azimuth plate 12. Depending upon the dimensions and or design loads of the desired antenna and mounting assembly, any number of az-lockdown fasteners 20 and corresponding az-lockdown slots 22 may be applied. One skilled in the art will recognize that an equivalent alternative structure is the location of the az-lockdown slots 22 in the az-lockdown fastener 20 connecting surfaces 10 of the primary mount, in addition to or rather than in the azimuth plate 12.

Fine azimuth adjustment of the antenna mount may be driven by rotation of an azimuth bolt 26. For example, the azimuth bolt 26 may be rotatably retained at a fixed end 28 to the azimuth plate 12 via a pair of split inserts 32 keyed to and retained around a groove 34 of the azimuth bolt 26, the split inserts 32 held within a plummer pin 36 fixed to the azimuth plate 12. At a movable end 30 the azimuth bolt 26 threads into, for example, a threaded insert 38 seated in another plummer pin 36 formed in the head 40 of one of the az-lockdown fasteners 20. Incremental rotation of the azimuth bolt 26, rotatably fixed to the azimuth plate 12 and threadably connected to an az-lockdown fastener 20, the az-lockdown fastener 20 coupled to a connecting surface 10, operates to pivot the azimuth plate 12 about the az-pivot fastener 16 in fine increments proportional to the thread pitch of the azimuth bolt 26 threads.

Operator feedback indicia related to the azimuth fine adjustment may also be incorporated in the antenna mount. An az-thimble 42 with graduated indicia 44 of, for example, 0-100 graduations may be added to the azimuth bolt 26 to enable repeated fine tuning of known increments less than a full rotation of the azimuth bolt 26 with respect to a stationary reference point.

Elevation adjustment functionality may be added to the antenna mount via the addition of a generally U-shaped elevation bracket 46 with elevation angled ends 48 arranged to rotate around an elevation pivot formed by el-pivot fasteners 50 that couple the elevation angled end(s) 48 of the elevation bracket 46 to the azimuth angled ends 14 of the azimuth plate 12. For ease of rotation and a reduced manufacturing precision requirement, elevation pivot washers 52 may be applied to the el-pivot fasteners 50.

A selected elevation angle of the elevation bracket 46 about the elevation pivot may be locked by el-lockdown fasteners 54 coupling the elevation bracket 46 to the azimuth angled ends 14 through corresponding arc slots 56 formed in the elevation angled ends 48 having a radius of curvature generally about the elevation pivot.

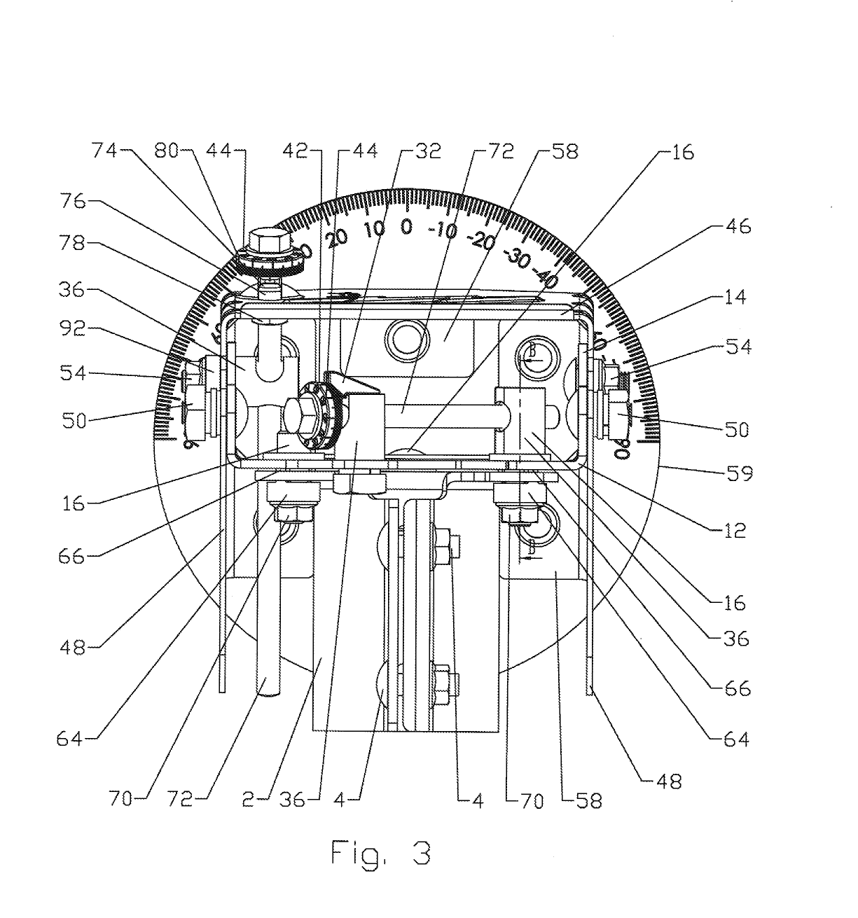

The antenna may be directly coupled to the elevation bracket 46 via, for example, mounting tabs 58 (FIG. 3) or to an antenna mounting surface 59 that then is coupled to the mounting tabs 58. The antenna mounting surface 58 is useful where a further rotational tilt adjustment mechanism is desired between the antenna and the antenna mount. To reduce the number of discrete components, the antenna mounting surface 59 may be permanently coupled to the mounting tabs 58 and or elevation bracket 46 via rivets, spot welding or the like.

The antenna (not shown) attachment typically results in a combined center of gravity that is located forward of the az-pivot fastener 16. Therefore, a cantilever effect acting on a fulcrum at the az-pivot fastener 16 will urge a gap to open between the azimuth plate 12 and the primary mount 2 connecting surfaces 10 at the az-lockdown fasteners 20 when the az-lockdown fasteners 20 are loosened for azimuth adjustment, thus causing a lockdown shift when the az-lockdown fasteners 20 are finally locked down. To counteract pointing errors arising from the cantilever effect and lockdown shift, the present invention, as best shown in FIGS. 3, 6 and 8, applies a retaining spacer 60 inserted along the az-lockdown fasteners 20, seated within the az-lockdown slots 22 between the az-lockdown fastener head 62 and the connecting surface 10. The retaining spacers 60 each have a height selected to be slightly more than a thickness of the azimuth plate 12. Thereby, when the az-retaining nuts 24 are tightened against the connecting surface 10, the underside of the az-lockdown fastener heads 62 form a retaining surface spaced away from the connection plate 20 by the height of the retaining spacers 60, retaining the azimuth plate 12 against the connecting surface 20. Because the azimuth plate 12 is slightly thinner than the retaining spacer height 60, the pivot action of the azimuth plate 12 about the az-pivot fastener 16 is still enabled and any gap between the azimuth plate 12 and the connecting surfaces 10 of the primary mount 2 due to the cantilever effect is maintained as a constant.

Alternatively, the retaining spacer 60 may be formed integral with the az-lockdown fastener 20 as a shoulder of the desired height below the az-lockdown fastener head 62. The shoulder having a diameter less than the diameter of the az-lockdown slot 22 but larger than the associated connecting surface 10 az-lockdown fastener 20 hole.

To finally lock down the azimuth plate 12 with respect to the connecting surfaces 20, an az-lockdown spacer 64 having at least one projection 66 that passes around the az-retaining nut 24 and through a corresponding projection hole 68 in the connecting surface 10 is retained at the bottom of the az-lockdown fasteners 20 by an az-lockdown nut 70. Preferably, at least two projections 66 are applied, so that the az-lockdown spacer 64 seats evenly via the projections 66 against the azimuth plate 12. Because the projections 66 pass through projection holes 68 of the connecting surfaces 10, a compression force is not applied between the azimuth plate 12 and the connecting surfaces 10 as the az-lockdown nut 70 is tightened against the azimuth lockdown spacer 64, driving the projections 66 to lock against the azimuth plate 12 to prevent further pivot of the azimuth plate 12 via the az-lockdown slots 22.

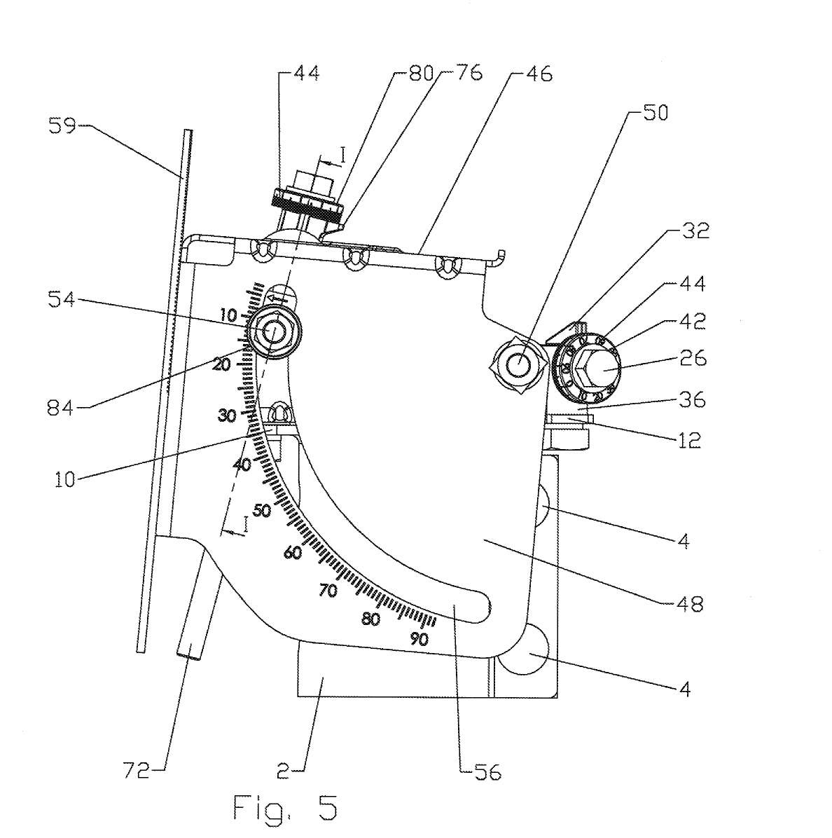

Similar to the azimuth fine adjustment, as best shown in FIGS. 5 and 10, fine elevation adjustment functionality may be added to an antenna mount according to the invention by the addition of an elevation bolt 72 coupled between the elevation bracket 46 and at least one of the el-lockdown fastener(s) 54. As the elevation bracket 46 may be adapted to move though a wide angular range of movement, the threaded elevation bolt 72 connection to the elevation bracket 46 is provided with a corresponding angular movement capability. An aperture 74 in the elevation bracket 46 may be formed with rounded edge(s) adapted to seat and rotatably key an elevation pointer 76 rotatably coupled to the elevation bolt 72. The elevation pointer 76 is retained in the aperture 74 against the elevation bracket 46, for example, by an elevation bolt nut 78 fixed in place upon the elevation bolt 72 by crimping, thread adhesive or the like. An el-thimble 80 with graduated indicia 44 of, for example, 0-100 graduations may be added, keyed to the elevation bolt 72, between the elevation pointer 76 and the head of the elevation bolt 72 to provide high resolution operator feedback on the threading progress of the elevation bolt 72 to pivot the elevation bracket 46 to a desired angle about the elevation pivot. Angular changes occurring at the el-lockdown fastener 54 that the elevation bolt 72 threads into, for example via another threaded insert 38 that fits into a plummer pin 36 of an el-lockdown fastener 54, are compensated for by rotation of the threaded insert 38 within the plummer pin 36.

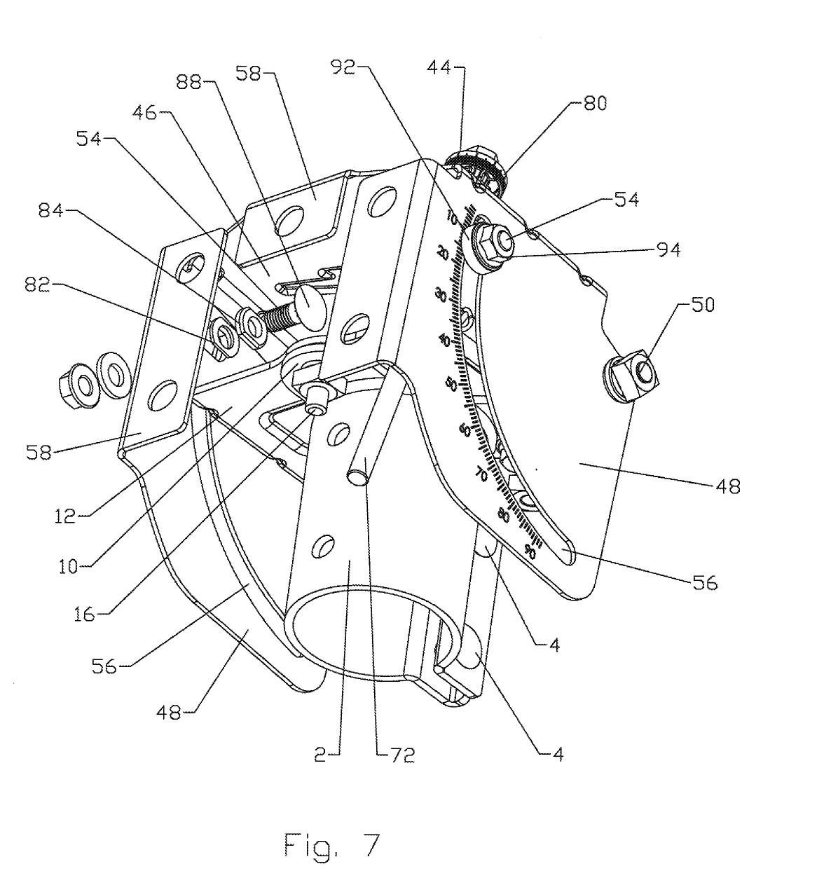

To minimize lockdown shift introduced with respect to the elevation adjustment, as best shown in FIGS. 7 and 9, the el-lockdown fastener 54 may be fitted with a washer 82 and an elevation spacer 84. The washer 82 and elevation spacer 84 initially fill an oversized elevation fastener hole 86 of the azimuth angled end 14. As tightening progresses, the elevation spacer 84, deforms and expands to fully fill the elevation fastener hole 86 but retains enough thickness to prevent the underside of the el-lockdown fastener bolt head 88 from contacting the azimuth angled end 14. The washer 82, generally sized to fill the elevation fastener hole 86 operates to prevent the elevation spacer 84 from projecting into the arc slot 56 as it deforms and expands. Because the underside of the el-lockdown fastener bolt head 88 never contacts the azimuth angled end 14, potential for deformation of the azimuth angled end 14 is reduced, minimizing the introduction of lockdown shift from final tightening of the el-lockdown fasteners 54. Alternatively and or in combination, as best shown in FIG. 10, the el-lockdown fastener 54 may be supplied with an el-retaining nut 90, pre-tightened to a point where elevation pivoting remains enabled but where minimal play remains, and an el-lockdown spacer 92 which fits around the el-retaining nut 90 to bear upon the elevation angled end, retained by an el-lockdown nut 94.

One skilled in the art will appreciate that the main components of the invention may be cost effectively fabricated by metal stamping. Alternatively, die casting and or injection molding may be applied. The specific exemplary embodiment of the invention described herein in detail is demonstrated with respect to a vertical pole mounting but may alternatively be readily adapted to a particular desired mounting surface and or mounting surface orientation. While the present invention has been demonstrated with mating u-brackets, equivalent elevation pivoting structures may be formed by mating angle or T-brackets having sufficient materials strength to withstand the expected weight and environmental stresses upon the antenna mount.

The present invention provides an antenna mount with precision alignment capability having significantly reduced complexity and manufacturing precision requirements, resulting in a significant reduction in overall cost. Also, the time required for installation and configuration of a reflector antenna incorporating an antenna mount according to the invention is similarly reduced by high resolution of alignment adjustments enabled by the azimuth and or elevation bolts 26, 72, aided by the graduated indicia of the az-thimble 42 and el-thimble 80.

Table of Parts

| | |
|---|---|
| 2 | primary mount |
| 4 | clamp fastener |
| 6 | coach bolt |
| 8 | serrated nut |
| 10 | connecting surface |
| 12 | azimuth plate |
| 14 | azimuth angled end |
| 16 | az-pivot fastener |
| 18 | washer |
| 20 | az-lockdown fastener |
| 22 | az-lockdown slot |
| 24 | az-retaining nut |
| 26 | azimuth bolt |
| 28 | fixed end |
| 30 | movable end |
| 32 | split insert |
| 34 | groove |
| 36 | plummer pin |
| 38 | threaded insert |
| 40 | head |
| 42 | az-thimble |
| 44 | graduated indicia |
| 46 | elevation bracket |
| 48 | elevation angled end |
| 50 | el-pivot fastener |
| 52 | elevation pivot washer |
| 54 | el-lockdown fastener |
| 56 | arc slot |
| 58 | mounting tab |
| 59 | antenna mounting surface |
| 60 | retaining spacer |
| 62 | az-lockdown fastener head |
| 64 | az-lockdown spacer |
| 66 | projection |
| 68 | projection hole |
| 70 | az-lockdown nut |
| 72 | elevation bolt |
| 74 | aperture |
| 76 | elevation pointer |
| 78 | elevation bolt nut |
| 80 | el-thimble |
| 82 | washer |
| 84 | elevation spacer |
| 86 | elevation fastener hole |
| 88 | el-lockdown fastener head |
| 90 | el-retaining nut |
| 92 | el-lockdown spacer |
| 94 | el-lockdown nut |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. An antenna mount, comprising:
a primary mount having a connecting surface for an azimuth plate;
the azimuth plate coupled to the connecting surface by an az-pivot fastener; the azimuth plate pivotable about the az-pivot fastener with respect to the connecting surface;
an az-lockdown fastener coupled to the connecting surface, passing through the an az-lockdown slot of the azimuth plate; and
a retaining spacer of the az-lockdown fastener positioned in the az-lockdown slot between the connecting surface and an underside of an az-lockdown fastener head; the retaining spacer having a height greater than a thickness of the azimuth plate.

2. The antenna mount of claim 1, wherein the az-pivot fastener has a washer thereon positioned between the connecting surface and the azimuth plate.

3. The antenna mount of claim 1, wherein the retaining spacer is formed integral with the az-lockdown fastener as a shoulder of the az-lockdown fastener.

4. The antenna mount of claim 1, further including an az-lockdown spacer of the az-lockdown fastener having at least one projection passing through a projection hole of the connecting surface to contact the azimuth plate; an
az-lockdown nut of the az-lockdown fastener retaining the az-lockdown spacer.

5. The antenna mount of claim 1, wherein the primary mount clamps around a distal end of a cylindrical mount point.

6. The antenna mount of claim 1, further including an azimuth bolt rotatably retained at a fixed end to the azimuth plate and at a movable end coupled by threads to the az-lockdown fastener.

7. The antenna mount of claim 6, wherein the azimuth bolt is rotatably retained at the fixed end by a pair of split inserts which key to a groove of the azimuth bolt, the split inserts held by a plummer pin connected to the azimuth plate.

8. The antenna mount of claim 6, wherein the azimuth bolt is threadably retained at the movable end by a threaded insert held by a plummer pin of the az-lockdown fastener.

9. The antenna mount of claim 6, further including an az-thimble coupled to the azimuth bolt; the az-thimble having graduated indicia visible about the az-thimble periphery.

10. The antenna mount of claim 1, further including an elevation bracket pivotably attached to an azimuth angled end of the azimuth plate; the elevation bracket provided with an elevation angled end coupled to the azimuth angled end by an el-pivot fastener;
the elevation bracket fixable at a desired angle by an el-lockdown fastener passing through an arc slot of the elevation angled end and connected to the azimuth angled end.

11. The antenna mount of claim 10, further including an expandable elevation spacer positioned in an el-lockdown fastener hole of the azimuth angled end; the expandable elevation spacer dimensioned to expand under compression to fill the el-lockdown fastener hole; the expandable elevation spacer having sufficient thickness to prevent seating of an el-lockdown fastener head upon the azimuth angled end.

12. The antenna mount of claim 10, further including an elevation bolt rotatably retained at a fixed end by the elevation bracket and at a movable end coupled by threads to the el-lockdown fastener.

13. The antenna mount of claim 12, wherein the elevation bolt is retained at the fixed end by an elevation pointer seated within and rotatably keyed by an aperture of the elevation bracket.

14. The antenna mount of claim 12, wherein the elevation bolt is retained at the movable end by a threaded insert seated in a plummer pin of the el-lockdown fastener.

15. The antenna mount of claim 10, wherein the elevation bracket has mounting tabs arranged normal to the elevation angle bracket for coupling to an antenna.

16. The antenna mount of claim 1, wherein the azimuth plate has two of the azimuth angled ends and the elevation bracket has two of the elevation angled ends; each of the angled ends having one of the arc slots; and each of the azimuth angled ends and the elevation angled ends generally parallel to one another.

17. The antenna mount of claim 1, wherein the primary mount is a pipe clamp for coupling to an end of a cylindrical body; the primary mount retained upon the cylindrical body via at least one clamp fastener.

18. The antenna mount of claim 17, wherein the connecting surfaces are normal to a longitudinal axis of the cylindrical body.

19. An antenna mount, comprising:
a primary mount having a connecting surface for an azimuth plate;
the azimuth plate coupled to the connecting surface by an az-pivot fastener; the azimuth plate pivotable about the az-pivot fastener with respect to the connecting surface;
an az-lockdown fastener coupled to the connecting surface; the az-lockdown fastener passing through the an az-lockdown slot of the azimuth plate;
a retaining spacer of the az-lockdown fastener positioned in the az-lockdown slot between the connecting surface and an underside of an az-lockdown fastener head; the retaining spacer having a height greater than a thickness of the azimuth plate;
an az-lockdown spacer of the az-lockdown fastener having at least one projection passing through a projection hole of the connecting surface to contact the azimuth plate; an az-lockdown nut of the az-lockdown fastener retaining the az-lockdown spacer.

20. An antenna mount, comprising:
a primary mount having a connecting surface for an azimuth plate;
the azimuth plate coupled to the connecting surface by an az-pivot fastener; the azimuth plate pivotable about the az-pivot fastener with respect to the connecting surface;
an az-lockdown fastener with an az-lockdown head, the az-lockdown fastener coupled to the connecting surface; the az-lockdown fastener passing through the an az-lockdown slot of the azimuth plate;
a retaining spacer of the az-lockdown fastener positioned in the az-lockdown slot between the connecting surface and an underside of the az-lockdown fastener head; the retaining spacer having a height greater than a thickness of the azimuth plate;
an az-lockdown spacer of the az-lockdown fastener having at least one projection passing through a projection hole of the connecting surface to contact the azimuth plate; an az-lockdown nut of the az-lockdown fastener retaining the az-lockdown spacer;
an azimuth bolt rotatably retained at a fixed end to the azimuth plate and at a movable end coupled by threads to the az-lockdown fastener;
an elevation bracket pivotably attached to an azimuth angled end of the azimuth plate; the elevation bracket provided with an elevation angled end coupled to the azimuth angled end by an el-pivot fastener;
the elevation bracket fixable at a desired angle by an el-lockdown fastener passing through an arc slot of the elevation angled end and connected to the azimuth angled end; and
an elevation bolt rotatably retained at a fixed end by the elevation bracket and at a movable end coupled by threads to the el-lockdown fastener.
